(19) United States
(12) Patent Application Publication
(10) Pub. No.: US 2006/0053274 A1
(43) Pub. Date: Mar. 9, 2006

(54) Information processing apparatus for changing firmware data

(76) Inventors: Masahito Nyuugaku, Hadano (JP); Daiki Abe, Hadano (JP); Nakaba Osano, Isehara (JP); Takeshi Kishida, Isehara (JP); Atsuo Kobayashi, Atsugi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/219,682

(22) Filed: Sep. 7, 2005

(30) Foreign Application Priority Data
Sep. 7, 2004 (JP) 2004-259310

(51) Int. Cl. G06F 15/177

(52) U.S. Cl. 713/1

(57) ABSTRACT

An information processing apparatus is characterized in that firmware is easily replaced in the case where a booting operating system is changed for another to improve the operational efficiency associated with the changing of the operating system; plural pieces of firmware, each of which is compatible with each of plural operating systems of different kinds, types or versions, are stored in a storage unit and each piece of firmware is provided with compatible information indicating which of the operating systems each pieces of firmware conforms to; and the type or version of operating system to boot is determined when booting the operating system, and firmware compatible with compatible information is selected from the storage unit for replacement on the basis on a determination result.

### CROSS-REFERENCE TO PRIOR APPLICATION

This application relates to and claims priority from Japanese Patent Application No. 2004-259310, filed on Sep. 7, 2004 the entire disclosure of which is incorporated herein by reference.

### BACKGROUND OF THE INVENTION

The present invention relates to an information processing apparatus for changing firmware data, and particularly, to a technique that allows for changing firmware data to be implemented in response to the booting of plural operating systems (OSes).

There is known an information processing apparatus in which plural pieces of firmware that are different from each other are installed in advance, and the optimum piece of firmware is selected for implementation by switching among the plural pieces of firmware in accordance with a change in processor, application or the like.

For example, JP-A No. 2000-112752 (Reference 1) discloses a technique in which a diagnostic processor selects firmware data that is compatible with a processor to be provided to the processor based on the revision information of the processor that is held in the processor, and the processor replaces the firmware data in use for the selected firmware data that is stored in a main storage unit, thereby selecting and implementing the firmware that is compatible with each of the different revisions of the processors.

In addition, JP-A No. H5-100861 (Reference 2) discloses a technique in which plural pieces of firmware, each of which is associated with each kind of application programs, are installed in advance, the relevant firmware is selected for replacement at the time of booting one of the application programs, and then the application program is booted. This technique is an example of replacing firmware to achieve the maximum performance.

### SUMMARY OF THE INVENTION

The techniques described in References 1 and 2 refer to switching of firmware in the case where the revision of a processor differs for each processor, that is, the revision of a hardware function differs, and switching of firmware in order to exploit the maximum performance of an application program.

Incidentally, in some cases, one computer allows plural OSes that are different from each other to run on the computer and the booting OS is sequentially switched among the plural OSes for use. For example, there is a case that in a processing apparatus that can be physically partitioned into plural physical partitions for use, each of different OSes runs on each physical partition. In such a case, there is the necessity of replacing the firmware in use with another that is compatible with the OS on each physical partition in order to operate the OS without any problems. This is because firmware operates differently on most OSes.

For example, there is a case that even in the case of OSes of the same kind, firmware operates differently depending on the version of the OS, or trouble in an OS causes the firmware on the OS to operate differently from the firmware on another OS. There is also a case that firmware on an OS does not operate in line with the specification, or some OSes allow only the authorized firmware to be used.

The object of the present invention is to easily perform replacing of firmware in the case where the booting OS is changed for another, thus improving the operational efficiency associated with the change of the booting OS.

The present invention is configured so that when the booting OS is changed for another, firmware compatible with the changed OS is automatically selected for replacement.

In a preferred embodiment, in an information processing apparatus where OSes selectively operate, a processing apparatus for firmware data management integrally manages plural pieces of firmware data, each of which is compatible with each of the OSes that are different from each other. Further, in a preferable method of changing firmware, plural pieces of firmware, each of which is compatible with each of plural OSes of different kinds, are stored in a storage unit in advance, and the kind of OS to boot is determined in a central processing apparatus. Based on a determination result, the firmware compatible with the OS to boot is selected from the storage unit and the selected firmware is stored in storage means to be implemented on the OS.

According to the present invention, operations of replacing firmware are automatically performed when the booting OS is changed for another, thus improving the operational efficiency and the operation ratio of the system. Further, the provision of a processing apparatus for integrally managing firmware data allows for simple management of the firmware, thus decreasing the management steps.

### BRIEF DESCRIPTION OF THE DRAWINGS

FIG. 1 is a diagram for showing a configuration of an information processing apparatus according to an embodiment;

FIG. 2 is a diagram for explaining an operation of replacing firmware in the information processing apparatus according to the embodiment;

FIG. 3 is an operational view for showing an operation of generating boot OS information in a bootloader according to another embodiment; and

FIG. 4 is an operational view for showing an operation of generating boot OS information in an OS according to yet another embodiment.

### DETAILED DESCRIPTION OF THE PREFERRED EMBODIMENT

Hereinafter, the embodiments of the present invention will be described with reference to the drawings.

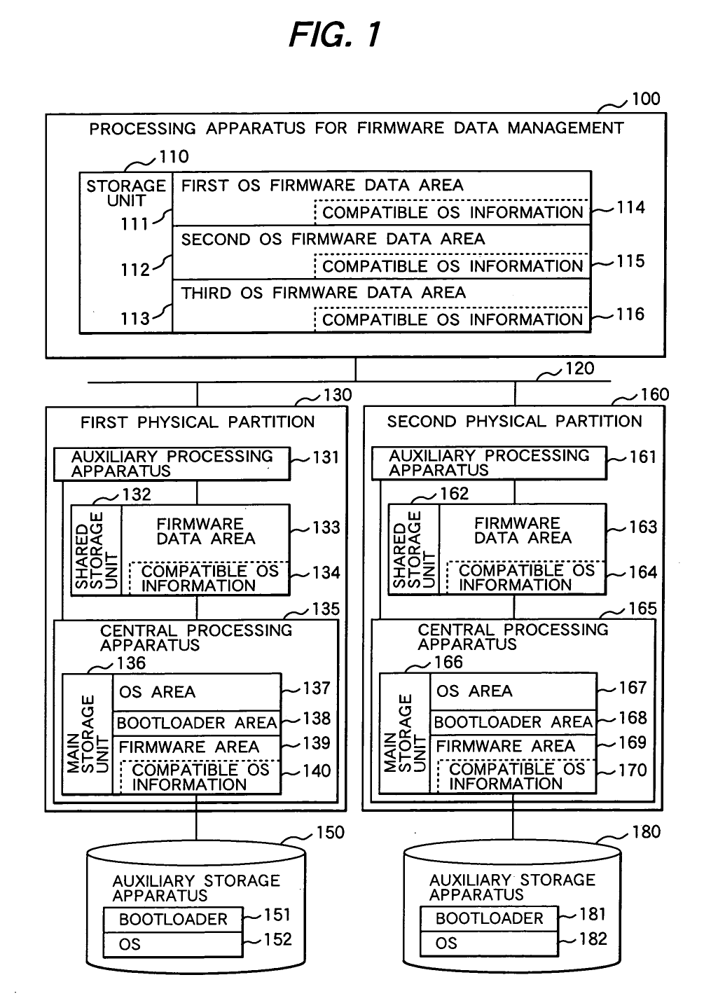

FIG. 1 shows a configuration of an information processing apparatus according to an embodiment.

The information processing apparatus includes a processing apparatus 100 for firmware data management, a first physical partition 130 and a second physical partition 160, both of which are physically partitioned, and auxiliary storage apparatuses 150, 180, each of which is connected to each of the physical partitions. The processing apparatus 100 for firmware data management is connected to the first physical partition 130 and the second physical partition 160 through a communication channel 120. In view of a hardware configuration, each of the physical partitions 130, 160 is composed of at least one processor and the processing apparatus 100 for firmware data management is composed of at least one processor.

The invention has a characteristic that, in this embodiment, the processing apparatus 100 for firmware data management integrally manages plural pieces of firmware data, each of which is compatible with each of plural OSes that are different from each other. This configuration eliminates the need of holding the plural pieces of firmware in a storage unit of an auxiliary processing apparatus on each of the physical partitions 130, 160.

The processing apparatus 100 for firmware data management includes a storage unit 110. The storage unit 110 is configured by a first OS firmware data area 111, a second OS firmware data area 112 and a third OS firmware data area 113, all of which store plural pieces of OSes data that are different from each other. The OS firmware data areas 111 to 113 respectively include compatible OS information 114, 115 and 116, each of which is compatible with each of the OSes.

For example, firmware compatible with Linux(registered trademark) and the compatible OS information 114 compatible with Linux(registered trademark) are stored in the first OS firmware data area 111. Firmware compatible with Windows(registered trademark) and the compatible OS information 115 compatible with Windows (registered trademark) are stored in the second OS firmware data area 112. Firmware compatible with HP-UX(registered trademark) and the compatible OS information 116 compatible with HP-UX(registered trademark) are stored in the third OS firmware data area 113. Note that each of the first OS firmware data area 111, the second OS firmware data area 112 and the third OS firmware data area 113 is the area for storing each piece of firmware data compatible with each of the OSes that are different from each other. Each piece of firmware data can be stored therein in random order.

As an option, it is conceivable to place the storage unit 110 in each of auxiliary processing apparatuses 131, 161 on the physical partitions 130, 160. However, whatever the case may be, the invention has a characteristic that the information processing apparatus carries the processing apparatus for firmware data management that stores, in its storage unit, the plural pieces of firmware data, each of which is compatible with each OS.

The first physical partition 130 is composed of the auxiliary processing apparatus 131, the central processing apparatus 135, a shared storage unit 132 which is shared by the auxiliary processing apparatus 131 and the central processing apparatus 135, and the auxiliary storage apparatus 150.

The shared storage unit 132 has an area with capacity enough to store the above-described OS firmware data. For the sake of simple explanation, the embodiment will be described on the assumption that compatible OS information 134 and a firmware data area 133 including the compatible OS information 134 in the shared storage unit 132 stores in advance, for example, compatible OS information compatible with Windows(registered trademark), and firmware compatible with Windows(registered trademark), respectively.

The auxiliary processing apparatus 131 replaces the firmware data stored in the shared storage unit 132 with the firmware data stored in the storage unit 110 of the processing apparatus 100 for firmware data management. In addition, the auxiliary processing apparatus 131 issues a reset direction to the central processing apparatus 135. The invention has a characteristic that, like this embodiment, each of the auxiliary processing apparatuses 131, 161 is provided in each of the physical partitions 130, 160. Each of the auxiliary processing apparatuses 131, 161 is composed of at least one processor, and even if the booting OSes are replaced, each of the apparatuses 131, 161 can operate under each of the alternative OSes. The auxiliary processing apparatuses 131, 161 may perform a control such as monitoring of respective sensors arranged in the physical partition belonging to each of the apparatuses 131, 161, in addition to the control of replacing firmware as described above.

The central processing apparatus 135 includes a main storage unit 136 which has an OS area 137, a bootloader area 138 and a firmware area 139. Each of the areas 137 to 139 has capacity enough to respectively store an OS and a bootloader that are read from the auxiliary storage apparatus 150 and firmware that is expanded from the shared storage unit 132. The main storage unit 136 also has an area of compatible OS information 140 which is a part of the firmware area 139.

The auxiliary storage apparatus 150 stores a bootloader 151 and an OS 152 in which, for example, a bootloader for Linux(registered trademark), and Linux(registered trademark) are stored, respectively.

A hardware configuration of the second physical partition 160 is the same as that of the first physical partition 130. The embodiment assumes that compatible OS information 164 and a firmware data area 163 including the compatible OS information 164 in the shared storage unit 162 on the second physical partition 160 store in advance, for example, compatible OS information compatible with Windows(registered trademark), and firmware compatible with Windows(registered trademark), respectively. In addition, the embodiment assumes that a bootloader 181 and an OS 182 in the auxiliary storage apparatus 180 store, for example, a bootloader for HP-UX(registered trademark), and HP-UX(registered trademark), respectively.

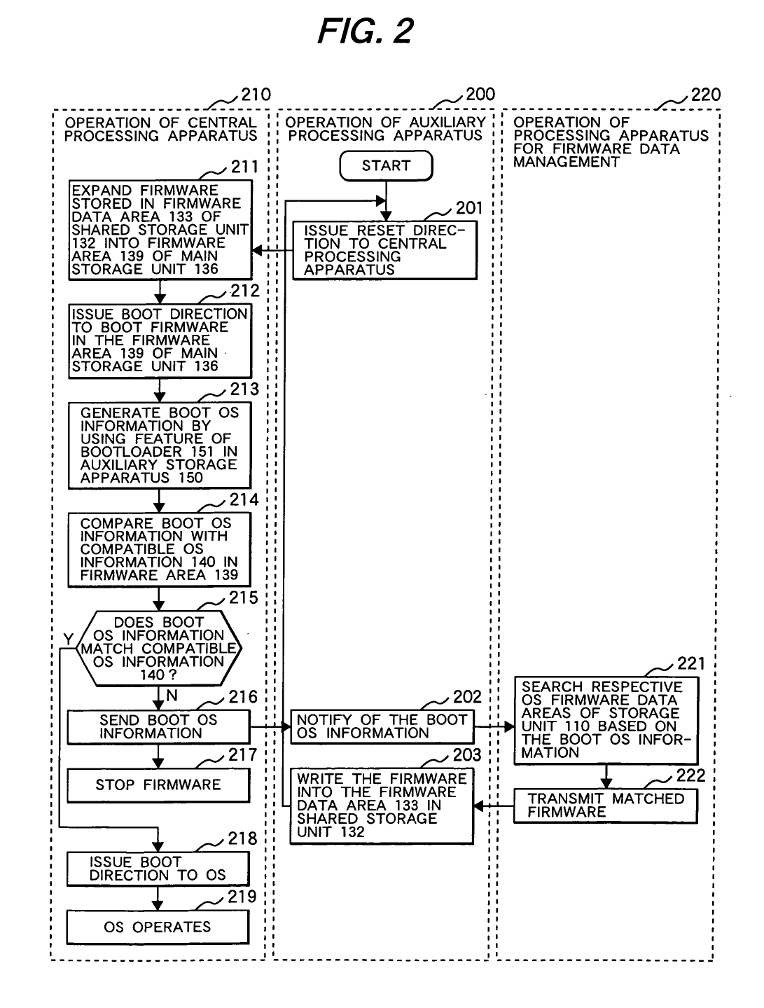

Next, an operation of replacing firmware in the information processing apparatus will be described with reference to FIG. 2. The portions enclosed with dotted lines in FIG. 2, namely, an operation 210 of the central processing apparatus, an operation 200 of the auxiliary processing apparatus, and an operation 220 of the processing apparatus for firmware data management show operations of the central processing apparatus 135, the auxiliary processing apparatus 131, and the processing apparatus 100 for firmware data management, respectively. FIG. 2 shows relative operations between the respective apparatuses as a whole. The operation 210 of the central processing apparatus and the operation 200 of the auxiliary processing apparatus are the same in the second physical partition 160 as those in the first physical partition 130.

First, the auxiliary processing apparatus 131 on the first physical partition 130 issues a reset direction to the central processing apparatus 135 on the same partition 130 (201). The central processing apparatus 135 that has received the reset direction on the first physical partition 130 expands the firmware stored in the firmware data area 133 of the shared storage unit 132 into the firmware area 139 of the main storage unit 136 in the central processing apparatus 135 on the same partition 130 (211), and then directs to boot the firmware expanded in the firmware area 139 of the main storage unit 136 (212).

The booted firmware in the firmware area 139 generates boot OS information by using a feature of the bootloader 151 in the auxiliary storage apparatus 150 (213). Then, the generated boot OS information is compared with the compatible OS information 140 in the firmware area 139 (214). Thereafter, it is determined whether or not the generated boot OS information matches the compatible OS information 140 (215).

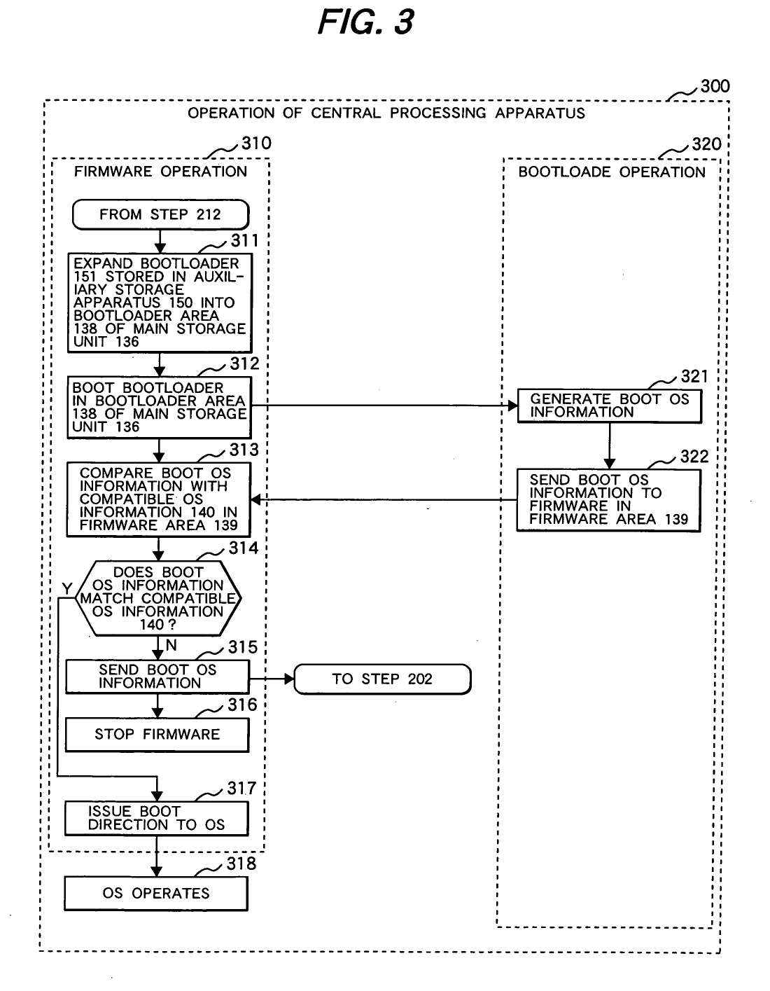

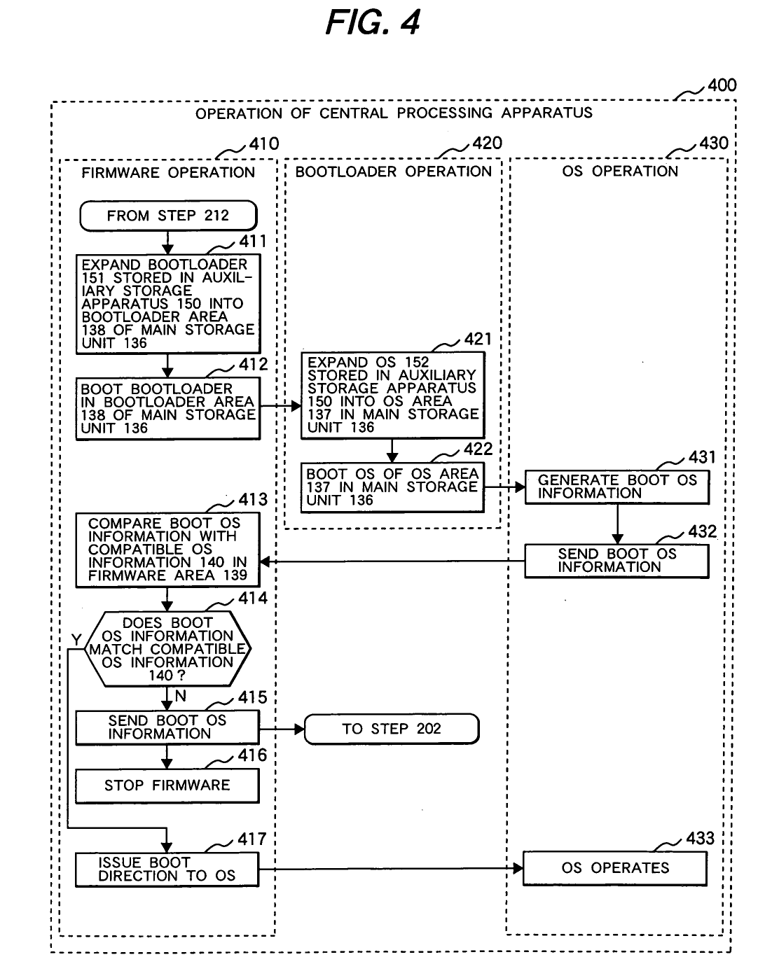

In Step 213, as a method of generating the boot OS information, the boot OS information is generated by using a file name of the bootloader 151 in the auxiliary storage apparatus 150. Further, the boot OS information is generated by the bootloader 151 or the OS 152 so as to be sent to the firmware in the firmware area 139 by providing the bootloader 151 or the OS 152 with a function of sending the boot OS information, which will be described later using FIGS. 3 and 4. In addition, some other methods are also conceivable. As an option, it is conceivable to process at least one of Steps 214 and 215 in the operation 200 of the auxiliary processing apparatus. However, whatever the case may be, the invention has significance in that the information processing apparatus is provided with the determination means which can determine the type of OS to boot.

In the case where the determination result of Step 215 shows that the generated boot OS information matches the compatible OS information 140, the OS stored in the OS area 137 of the main storage unit 136 is directed to boot (218), and then the OS operates (219). On the other hand, in the case where the determination result of Step 215 shows that the generated boot OS information does not match the compatible OS information 140, the central processing apparatus 135 sends the generated boot OS information to the auxiliary processing apparatus 131 (216), and the firmware in the central processing apparatus 135 is stopped (217).

Further, the auxiliary processing apparatus 131 sends the boot OS information to the processing apparatus 100 for firmware data management, which information has been sent in S216, through the communication channel 120 (202).

The processing apparatus 100 for firmware data management searches the respective compatible OS information 114, 115 and 116 of the storage unit 110 in the apparatus 100 on the basis of the boot OS information (221), and then transmits the firmware compatible with the boot OS information to the auxiliary processing apparatus 131 on the first physical partition 130 through the communication channel 120 (222).

The auxiliary processing apparatus 131 on the first physical partition 130 writes the received firmware data into the firmware data area 133 in the shared storage unit 132 (203), and issues a reset direction to the central processing apparatus 135 (201).

FIG. 3 is a diagram for explaining a method of generating boot OS information according to another embodiment.

That is, the boot OS information is generated by the bootloader so as to be sent to the firmware in the firmware area 139 by providing the bootloader with a function of sending the boot OS information, so that the type of OS to boot is determined. As shown in FIG. 3, an operation 300 of the central processing apparatus 135 to generate boot OS information is composed of a firmware operation 310 and a bootloader operation 320. An operation of FIG. 3 will be described below by replacing Steps 213 to 219 in FIG. 2 with other steps.

The firmware, which has been booted in S212 of FIG. 2, in the firmware area 139 of the main storage unit 136 expands the bootloader 151 stored in the auxiliary storage apparatus 150 into the bootloader area 138 of the main storage unit 136 in the central processing apparatus 135 (311). The bootloader expanded in the bootloader area 138 of the main storage unit 136 is booted (312).

The booted bootloader in the bootloader area 138 generates boot OS information (321). The boot OS information is sent to the firmware in the firmware area 139 of the main storage unit 136 (322). The firmware in the firmware area 139 of the main storage unit 136 compares the sent boot OS information with the compatible OS information 140 (313). Thereafter, it is determined whether or not the sent boot OS information matches the compatible OS information 140 in the firmware area 139 (314).

In the case where the determination result of Step 314 shows that the sent boot OS information matches the compatible OS information 140, the firmware stored in the firmware 139 of the main storage unit 136 directs the OS of the OS area 137 in the main storage unit 136 to boot (317), and the OS operates (318).

On the other hand, in the case where the determination result of Step 314 shows that the sent boot OS information does not match the compatible OS information 140, the boot OS information is sent to the auxiliary processing apparatus 131 on the first physical partition 130 (315), and an operation of the firmware stored in the firmware area 139 of the main storage unit 136 is stopped (316). The operations of Steps 202, 221, 222, 203 and 201 are performed after the sending operation in Step 315.

The operations of Steps 313 and 314 respectively correspond to those of Steps 214 and 215 described in FIG. 2. It is apparent that at least one of Steps 313 and 314 is operated by the auxiliary processing apparatuses 131.

FIG. 4 is a diagram for explaining a method of generating boot OS information according to yet another embodiment.

That is, the boot OS information is generated by the OS so as to be sent to the firmware in the firmware area 139 by providing the OS with a function of sending the boot OS information, so that the type of OS to boot is determined.

In FIG. 4, an operation 400 of the central processing apparatus 135 is composed of a firmware operation 410, a bootloader operation 420 and an OS operation 430. An operation of FIG. 4 will be described below by replacing Steps 213 to 219 in FIG. 2 with other steps.

The firmware, which has been booted in S212 of FIG. 2, in the firmware area 139 of the main storage unit 136 expands the bootloader 151 stored in the auxiliary storage apparatus 150 into the bootloader area 138 of the main storage unit 136 in the central processing apparatus 135 (411). The bootloader expanded in the bootloader area 138 of the main storage unit 136 is booted (412).

The booted bootloader in the bootloader area 138 expands the OS 152 of the auxiliary storage apparatus 150 into the OS area 137 in the main storage unit 136 (421) to boot the OS in the OS area 137 of the main storage unit 136 (422). The booted OS generates boot OS information (431), and sends of the boot OS information to the firmware stored in the firmware area 139 of the main storage unit 136 (432). The operations of Steps 413 to 417 and 433 respectively correspond to those of Steps 313 to S318 described in FIG. 3. Therefore, explanation thereof will be omitted.

With the above-described operations, the firmware on the first physical partition 130, for example, the firmware compatible with Windows(registered trademark) can be automatically replaced by the firmware compatible with Linux(registered trademark) to boot that is stored in the OS 152. The firmware on the second physical partition 160 can be also replaced by the firmware compatible with HP-UX(registered trademark) to boot that is stored in the OS 182 with the above-described operations.

In the above-described embodiments, it is mainly mentioned that the type of OS is automatically determined. However, it is apparent that determination can be made by including at least one of the type of OS and the version of OS in compatible OS information.

What is claimed is:

1. An information processing apparatus including storage means for storing firmware compatible with an operating system, and a central processing apparatus for performing data processing by allowing the operating system and the firmware to operate, the information processing apparatus comprising:
a storage unit for storing a plurality of pieces of firmware, each of which is compatible with each of a plurality of operating systems of different kinds;
determination means for determining the kind of operating system to boot;
selection means for selecting one of the plurality of pieces of firmware, which is compatible with the operating system to boot, on the basis of a result obtained by the determination means; and
replacing means for reading the firmware selected by the selection means from the storage unit for replacement.

2. The information processing apparatus according to claim 1, wherein the plurality of operating systems of different kinds include a plurality of operating systems of different types or a plurality of operating systems of different versions, and each of the plurality of pieces of firmware includes compatible information that indicates the firmware is compatible with at least one of the type of operating system and the version of operating system.

3. An information processing apparatus including a main storage unit for storing an operating system and firmware compatible with the operating system, and a processing apparatus for performing data processing by allowing the operating system and the firmware to operate, the information processing apparatus comprising:
a processing apparatus for firmware data management, which includes a storage unit for storing a plurality of pieces of firmware, each of which is compatible with each of a plurality of operating systems of different kinds;
a plurality of central processing apparatuses which are connected to the processing apparatus for firmware data management through a communication channel, and can be operated by the operating systems;
auxiliary storage apparatuses, each of which is provided while corresponding to each of the plurality of central processing apparatuses, and stores one of the operating systems;
determination means which determines the kind of operating system to boot when the operating system stored in the auxiliary storage apparatus is booted in the central processing apparatus;
selection means which selects one of the plurality of pieces of firmware, which is compatible with the operating system to boot, from the storage unit of the processing apparatus for firmware data management on the basis of a result obtained by the determination means; and
auxiliary processing apparatuses which include replacing means for obtaining the firmware selected by the selection means from the processing apparatus for firmware data management to replace the firmware stored in the main storage unit of the central processing apparatus, each of the auxiliary processing apparatuses being provided while corresponding to each of the plurality of central processing apparatuses.

4. The information processing apparatus according to claim 1, wherein the determination means is means in which the firmware stored in the main storage unit of the central processing apparatus determines the type of operating system to boot by using a name of a bootloader which boots the operating system.

5. The information processing apparatus according to claims 1, wherein the determination means is means in which the bootloader which boots the operating system notifies the firmware stored in the main storage unit of the central processing apparatus, of at least one of the type of operating system or the version of operating system.

6. The information processing apparatus according to claims 1, wherein, in the determination means, the operating system notifies the firmware stored in the main storage unit of the central processing apparatus, of at least one of the type of operating system or the version of operating system.

7. The information processing apparatus according to claim 3, wherein the determination means is means in which the firmware stored in the main storage unit of the central processing apparatus determines the type of operating system to boot by using a name of a bootloader which boots the operating system.

8. The information processing apparatus according to claims 3, wherein
the determination means is means in which the bootloader which boots the operating system notifies the firmware stored in the main storage unit of the central processing apparatus, of at least one of the type of operating system or the version of operating system.

9. The information processing apparatus according to claims 3, wherein, in the determination means, the operating system notifies the firmware stored in the main storage unit of the central processing apparatus, of at least one of the type of operating system or the version of operating system.

10. A method of changing firmware in an information processing apparatus which stores firmware compatible with an operating system in storage means, and performs data processing by allowing the operating system and the firmware to operate in a central processing apparatus, comprising:
storing a plurality of pieces of firmware, each of which is compatible with each of a plurality of operating systems of different kinds, in a storage unit in advance;
determining the kind of operating system to boot in the processing apparatus;
selecting the firmware compatible with the operating system to boot from the storage unit on the basis of a determination result; and
storing the selected firmware in the storage means to run on the operating system.
